(19) United States
(12) Patent Application Publication
(10) Pub. No.: US 2010/0158515 A1
(43) Pub. Date: Jun. 24, 2010

(54) TRANSMISSION SYSTEM AND TEST APPARATUS

(75) Inventors: DAISUKE WATANABE, Saitama (JP); TOSHIYUKI OKAYASU, Saitama (JP)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ADVANTEST CORPORATION, TOKYO (JP)

(21) Appl. No.: 12/339,075

(22) Filed: Dec. 19, 2008

(51) Int. Cl. H04B 10/04; H04B 10/08

(52) U.S. Cl. 398/25; 398/186

(57) ABSTRACT

Provided is a transmission system that transmits data, comprising a modulating section that modulates amplitude of a predetermined carrier signal according to the data to be transmitted; an electro-optical converting section that converts a modulated signal output by the modulating section into an optical signal; an optical fiber that transmits the optical signal; an optical-electric converting section that converts the optical signal transmitted by the optical fiber into a current signal; a current-voltage converting section that linearly converts the current signal into a voltage signal; and a demodulating section that demodulates the voltage signal.

### BACKGROUND

1. Technical Field

The present invention relates to a transmission system and a test device.

2. Related Art

Most transmission systems that transmit optical signals include laser diodes, optical fibers, and photo diodes. A substantial loss is incurred during long-distance optical transmission, and an equalizer circuit is often provided to compensate for this loss. Even during short-distance optical transmission, an equalizer circuit is sometimes used to compensate the operational frequency bands of the laser diode and the photo diode.

The equalizer circuit performs compensation in the same manner for both the loss compensation and the band compensation. More specifically, the equalizer circuit performs the loss compensation and the band compensation in a signal by inserting a high-pass filter into the signal path to increase gain of the high frequency component.

In most cases, one equalizer circuit is provided on a transmission side and one equalizer circuit is provided on a reception side. Therefore, if the cutoff frequency of each element in the transmission system is significantly different, it is difficult to provide the high-pass filter.

As an example, assume that the high-range cutoff frequency of the laser diode is 10 GHz and the high-range cutoff frequency of the optical fiber is 500 MHz. When the frequency of the transmitted signal is 10 GHz, the optical fiber requires an equalization of 20 dB while the laser diode does not require any equalization, resulting in an unbalanced state.

Since only one equalizer circuit is provided on the transmission side, the equalizing amount of the transmission-side equalizer circuit is optimized for the optical fiber, which is the greatest cause of signal decay. When the equalizer circuit is optimized for the optical fiber, however, am over-emphasized bandwidth occurs in the laser diode. In such a case, the modulated waveform of the laser diode becomes more distorted, which causes a greater decrease in the transmission quality.

This problem can be solved by setting the cutoff frequency of each element in the transmission system to be substantially the same. But since the cutoff frequency of the optical fiber depends on the transmission distance, it is difficult for every element in the transmission system to have substantially the same cutoff frequency. When the cutoff frequency of each element in the transmission system is significantly different, the performance of the laser diode and the like can be stabilized by slowing the transmission rate to correspond to the lowest cutoff frequency, but the slowed transmission rate is undesirable.

### SUMMARY

Therefore, it is an object of an aspect of the innovations herein to provide a transmission system and a test apparatus, which are capable of overcoming the above drawbacks accompanying the related art. The above and other objects can be achieved by combinations described in the independent claims. The dependent claims define further advantageous and exemplary combinations of the innovations herein.

According to a first aspect related to the innovations herein, one exemplary transmission system may include a transmission system that transmits data, comprising a modulating section that modulates amplitude of a predetermined carrier signal according to the data to be transmitted; an electro-optical converting section that converts a modulated signal output by the modulating section into an optical signal; an optical fiber that transmits the optical signal; an optical-electric converting section that converts the optical signal transmitted by the optical fiber into a current signal; a current-voltage converting section that linearly converts the current signal into a voltage signal; and a demodulating section that demodulates the voltage signal.

According to a second aspect related to the innovations herein, one exemplary test device may include a test device that tests a device under test, comprising a plurality of test modules that exchange signals with the device under test to test the device under test; and a transmitting section that transmits a signal at least between the plurality of test modules or between each test module and the device under test. The transmitting section includes a modulating section that modulates amplitude of a predetermined carrier signal according to the signal to be transmitted; an electro-optical converting section that converts a modulated signal output by the modulating section into an optical signal; an optical fiber that transmits the optical signal; an optical-electric converting section that converts the optical signal transmitted by the optical fiber into a current signal; a current-voltage converting section that linearly converts the current signal into a voltage signal; and a demodulating section that demodulates the voltage signal.

The summary clause does not necessarily describe all necessary features of the embodiments of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows an exemplary configuration of a transmission system 100 according to an embodiment of the present invention.

FIG. 2 shows an example of a transmission band of each element in the transmission channel 400.

FIG. 3 shows another exemplary configuration of the transmission system 100.

FIG. 4 shows another exemplary configuration of the transmission system 100.

FIG. 5 shows another exemplary configuration of the transmission system 100.

FIG. 6 shows another exemplary configuration of the transmission system 100.

FIG. 7 shows an exemplary configuration of a test device 600 according to another embodiment of the present invention.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

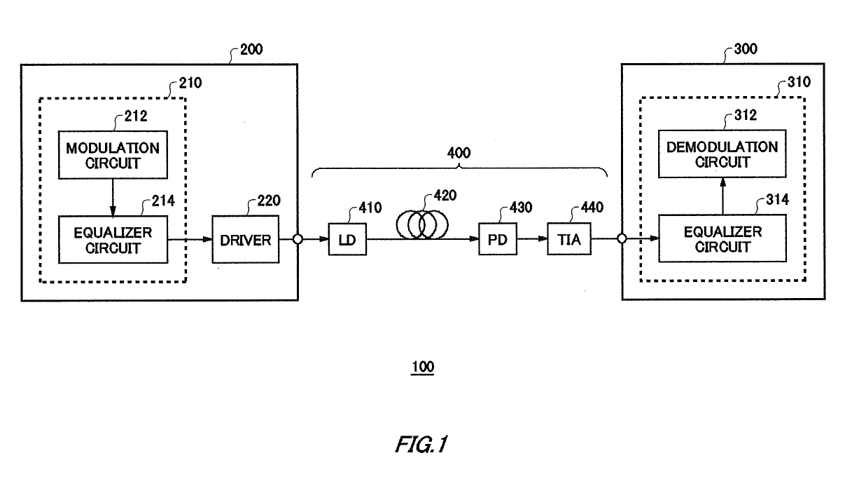

FIG. 1 shows an exemplary configuration of a transmission system 100 according to an embodiment of the present invention. The transmission system 100 transmits data via optical transmission, and is provided with a transmitting device 200, a transmission channel 400, and a receiving device 300.

The transmission system 100 of the present embodiment transmits data in a narrower occupied bandwidth by using multilevel amplitude modulation to modulate and demodulate the transmitted signal. For example, data transmission can be performed with the same occupied bandwidth when transmitting data at 10 Gbps using 4-value amplitude modulation and when transmitting data at 5 Gbps using 2-value amplitude modulation. In this way, the bandwidth in which the emphasis is to be performed becomes narrower, so that the equalizer can be set in accordance with the optical fiber or the like having the lowest cutoff frequency. Therefore, even if over-emphasis occurs in the laser diode or the like having a large cutoff frequency, the relative amount of the over-emphasized band that is used can be decreased, thereby decreasing the effect of the over-emphasis.

The transmitting device 200 outputs prescribed data under the control of a user or the like. The transmitting device 200 may output data according to an electric signal. The transmitting device 200 of the present embodiment includes a modulating section 210 and a driver 220.

The modulating section 210 modulates the amplitude of a preset carrier signal according to the data to be transmitted. The modulating section 210 of the present embodiment includes a modulation circuit 212 and a transmission equalizer circuit 214.

The modulation circuit 212 outputs a modulated signal. For example, the modulation circuit 212 outputs a PAM signal obtained by multilevel modulating the amplitude of each pulse according to the data to be transmitted. The modulation circuit 212 may instead output a signal obtained by quadrature modulating the carrier signal. The level of the amplitude direction in the multilevel modulation by the modulation circuit 212 is greater than 2.

The transmission equalizer circuit 214 adjusts a frequency characteristic of the modulated signal output by the modulation circuit 212. The transmission equalizer circuit 214 adjusts the frequency characteristic of the modulated signal in advance to perform at least one of the loss compensation and the band compensation in the transmission channel 400.

For example, the transmission equalizer circuit 214 uses a high-pass filter to increase the amplitude gain of a high-frequency band of the modulation circuit 212 to be greater than the amplitude gain in a low-frequency band. The transmission equalizer circuit 214 may set a boundary to be the lowest cutoff frequency from among the cutoff frequencies of the elements in the transmission channel 400, such that the amplitude gain of a component on the high-frequency side of the modulated signal becomes greater than a component on the low-frequency side of the modulated signal.

FIG. 1 shows an example in which the transmission equalizer circuit 214 is provided behind the modulation circuit 212, but the transmission equalizer circuit 214 may instead be provided in front of the modulation circuit 212 or inside of the modulation circuit 212. If the transmission equalizer circuit 214 is provided in front of the modulation circuit 212, the transmission equalizer circuit 214 may adjust the frequency band of the signal input to the modulation circuit 212. If the transmission equalizer circuit 214 is provided inside the modulation circuit 212, the transmission equalizer circuit 214 may adjust the frequency band of the signal generated in the modulation circuit 212. The driver 220 receives the modulated signal output by the modulating section 210 and outputs the modulated signal to the transmission channel 400.

The transmission channel 400 transmits the modulated signal from the transmitting device 200 to the receiving device 300. The transmission channel 400 of the present embodiment converts the modulated signal into an optical signal, and transmits the optical signal. The transmission channel 400 includes an electro-optical converting section 410, an optical fiber 420, an optical-electric converting section 430, and a current-voltage converting section 440.

The electro-optical converting section 410 is positioned near the transmitting device 200 to convert the modulated signal output by the transmitting device 200 into an optical signal and input the optical signal to the optical fiber 420. For example, the electro-optical converting section 410 may be a light emitting element such as a laser diode that emits light according to the modulated signal output by the transmitting device 200.

The optical fiber 420 transmits the optical signal received from the electro-optical converting section 410 to the optical-electric converting section 430. The length of the optical fiber 420 is substantially equal to the signal transmission distance between the transmitting device 200 and the receiving device 300.

The optical-electric converting section 430 is positioned near the receiving device 300 to receive the optical signal transmitted by the optical fiber 420. The optical-electric converting section 430 converts the optical signal into a current signal. The optical-electric converting section 430 may be a light receiving element such as a photo diode.

The current-voltage converting section 440 converts the current signal output by the optical-electric converting section 430 into a voltage signal. Since the transmission channel 400 of the present embodiment transmits a signal that is amplitude modulated, it is desirable that the current-voltage converting section 440 linearly convert the current signal into the voltage signal. The current-voltage converting section 440 may be a so-called linear trans-impedance amplifier (TIA).

The receiving device 300 receives the voltage signal from the transmission channel 400 and demodulates the voltage signal. The receiving device 300 is provided with a demodulating section 310 that includes a demodulation circuit 312 and a reception equalizer circuit 314.

The reception equalizer circuit 314 may adjust the frequency characteristic of the voltage signal received from the transmission channel 400. By combining the emphasis in the reception equalizer circuit 314 and the pre-emphasis in the transmission equalizer circuit 214, the transmission-side transmission equalizer circuit 214 and the reception-side reception equalizer circuit 314 can be set to perform the loss compensation and the band compensation of the transmission channel 400.

For example, the reception-side reception equalizer circuit 314 executes an emphasis that remains constant regardless of the transmission channel 400, and the transmission-side transmission equalizer circuit 214 executes a pre-emphasis that depends on the transmission channel 400. If the transmission-side transmission equalizer circuit 214 performs both the loss compensation and the band compensation for the transmission channel 400, the receiving device 300 need not include the reception equalizer circuit 314.

The demodulation circuit 312 demodulates the voltage signal emphasized by the reception equalizer circuit 314. The demodulation circuit 312 demodulates the voltage signal according to the modulation performed by the modulation circuit 212.

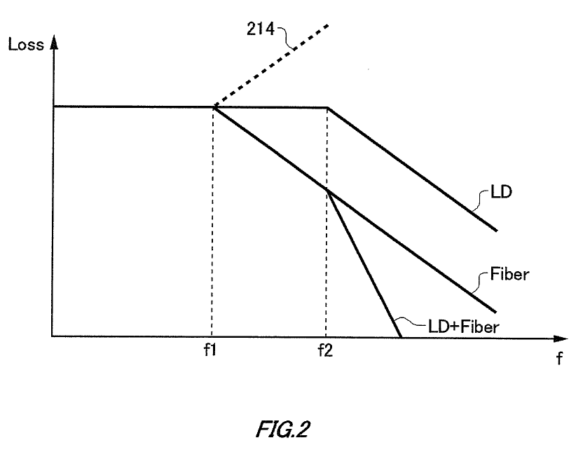

FIG. 2 shows an example of a transmission band of each element in the transmission channel 400. FIG. 2 shows the band (LD) of the electro-optical converting section 410, the band (Fiber) of the optical fiber 420, and the combined band (LD+Fiber) of the electro-optical converting section 410 and the optical fiber 420. The horizontal axis in FIG. 2 represents frequency as a logarithm, and the vertical axis represents transmission loss in decibels.

In this example, the cutoff frequency f1 of the optical fiber 420 is less than the cutoff frequency f2 of the electro-optical converting section 410. In this case, the transmission equalizer circuit 214 performs the pre-emphasis according to the frequency characteristics of the electro-optical converting section 410 and the optical fiber 420 such that the transmission characteristic of the signal is flat over all bands.

In this case, in a band from the frequency f1 to the frequency f2 for example, the frequency characteristic of the electro-optical converting section 410 is flat, but a signal in which the frequency component at this band is emphasized by the transmission equalizer circuit 214 is input to the electro-optical converting section 410. Therefore, the electro-optical converting section 410 receives an unnecessary emphasis component, which distorts the waveform of the signal output by the electro-optical converting section 410 and is a main cause of the increase in transmission error.

To solve this problem, the transmission system 100 can decrease the occupied bandwidth necessary for transmitting the signal by using multilevel amplitude modulation. In this way, the transmission system 100 decreases the region in which the occupied bandwidth necessary for transmitting the signal overlaps with the frequency band that is overemphasized with respect to the electro-optical converting section 410 or the like. As a result, the band that is overemphasized with respect to the electro-optical converting section 410 can be decreased.

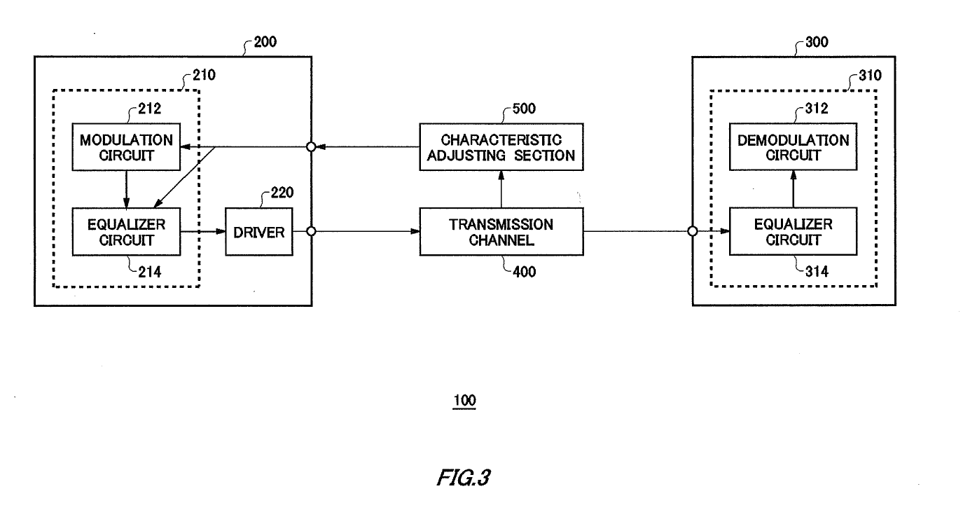

FIG. 3 shows another exemplary configuration of the transmission system 100. The transmission system 100 of the present embodiment further includes a characteristic adjusting section 500 in addition to the configuration of the transmission system 100 described in relation to FIG. 1. Other elements of the transmission system 100 may be the same as those of the transmission system 100 described in relation to FIG. 1. FIG. 3 shows the characteristic adjusting section 500 as being separate from the transmitting device 200 and the transmission channel 400, but the characteristic adjusting section 500 may instead be provided inside the transmitting device 200 or the transmission channel 400.

The characteristic adjusting section 500 adjusts the multilevel value in the modulation circuit 212 and the frequency characteristic in the transmission equalizer circuit 214, based on a characteristic of the transmission channel 400. For example, the characteristic adjusting section 500 sets the multilevel value in the modulation circuit 212 based on the cutoff frequency of any element of the transmission channel 400 and the number of bits to be transmitted by the transmission system 100 per unit time. The characteristic adjusting section 500 desirably sets the multilevel value in the modulation circuit 212 based on the lowest cutoff frequency from among the cutoff frequencies of the elements of the transmission channel 400 and the number of bits to be transmitted by the transmission system 100 per unit time.

The characteristic adjusting section 500 may set the multilevel value by comparing (i) the occupied bandwidth determined by this multilevel value in the modulation circuit 212 and the number of bits to be sent per unit time with (ii) the lowest cutoff frequency in the transmission channel 400. For example, assume that the element of the transmission channel 400 with the lowest cutoff frequency is the optical fiber at 500 MHz, and the number of bits to be sent per unit time is 10 Gbps. In this case, if the multilevel value in the modulation circuit 212 is set to 4, the occupied bandwidth necessary for data transmission is 5 GHz. If the multilevel value in the modulation circuit 212 is instead set to 16, the occupied bandwidth necessary for data transmission is 1.25 GHz.

The characteristic adjusting section 500 may set the multilevel value in the modulation circuit 212 such that a difference of the occupied bandwidth at the lowest cutoff frequency falls within a prescribed allowable range. The characteristic adjusting section 500 may select, from among the multilevel values that can be set in the modulation circuit 212, the greatest multilevel value that causes the difference of the occupied bandwidth at the lowest cutoff frequency to fall within the prescribed allowable range. For example, assuming the conditions described above, if the multilevel values that can be set in the modulation circuit 212 are powers of 2 and the difference of the occupied bandwidth at the lowest cutoff frequency is +0.5 GHz, the characteristic adjusting section 500 sets the multilevel value in the modulation circuit 212 to 16.

As described in relation to FIG. 2, the transmission equalizer circuit 214 adjusts the frequency characteristic of the modulated signal based on the lowest cutoff frequency from among the cutoff frequencies of the elements of the transmission channel 400 connected between the modulating section 210 and the demodulating section 310. The characteristic adjusting section 500 may notify the transmission equalizer circuit 214 concerning an attenuation amount of each frequency component and the cutoff frequency of each element of the transmission channel 400.

The characteristic adjusting section 500 may measure the attenuation amount of each frequency component and the cutoff frequency of each element of the transmission channel 400. The characteristic adjusting section 500 may instead receive this information from a user. As another example, the characteristic adjusting section 500 may read this information from the transmission channel 400 that stores the information in advance.

If the equalizing amount for the amplitude of the modulated signal in the transmission equalizer circuit 214 exceeds a prescribed threshold value at a prescribed frequency component, the modulation circuit 212 may increase the multilevel value in a direction of the amplitude of the modulated signal. Here, the “equalizing amount” refers to the amplitude gain.

The prescribed frequency component may be the greatest frequency component in the allowable range of difference of the occupied bandwidth at the lowest cutoff frequency. Since the occupied bandwidth is decreased by increasing the multilevel value in the modulation circuit 212, the modulation circuit 212 may increase the multilevel value of the modulated signal until the equalizing amount at the greatest frequency in the allowable range reaches the prescribed threshold value.

The adjustment of the multilevel value may be controlled by the characteristic adjusting section 500. The characteristic adjusting section 500 desirably controls the multilevel value in the demodulation circuit 312 according to the multilevel value in the modulation circuit 212. The characteristic adjusting section 500 may control the equalizing amount in the reception equalizer circuit 314. In this case, the characteristic adjusting section 500 sets the transmission equalizer circuit 214 and the reception equalizer circuit 314 such that the combined equalizing amount of the transmission equalizer circuit 214 and the reception equalizer circuit 314 compensates for the band and the loss in the transmission channel 400.

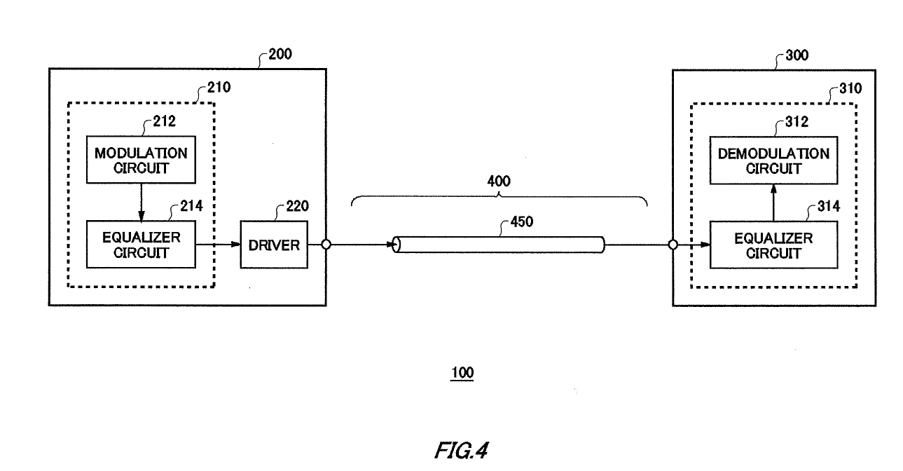

FIG. 4 shows another exemplary configuration of the transmission system 100. The transmission system 100 of the present embodiment differs from the transmission systems 100 described in FIGS. 1 to 3 in that the configuration of the transmission channel 400 is different. Other elements of the transmission system 100 may be the same as those of any one of the transmission systems 100 described in relation to FIGS. 1 to 3. Instead of the optical transmission channel including the electro-optical converting section 410, the optical fiber 420, the optical-electric converting section 430, and the current-voltage converting section 440, the transmission system 100 of the present embodiment is provided with an electric transmission channel that includes a transmission path 450 for transmitting an electric signal. The electric transmission channel connects the transmitting device 200 and the receiving device 300, and transmits electric signals therebetween.

When the transmission channel 400 is the electric transmission channel, the transmission equalizer circuit 214 may perform the equalization based on the attenuation amount and the cutoff frequency of the transmission path 450. The characteristic adjusting section 500 may set the equalizing amount in the transmission equalizer circuit 214 based on whether the transmission channel is the optical transmission channel or the electric transmission channel. In this case as well, the modulation circuit 212 may increase the multilevel value when the equalizing amount at a prescribed frequency exceeds the prescribed threshold value.

The transmission systems 100 described in relation to FIGS. 1 to 3 are provided with ROSA circuits and TOSA circuits, such as the electro-optical converting sections 410, at the ends of the transmission channels 400. The equalizer circuits in the transmitting and receiving devices are then provided depending on whether the transmission channel is optical or electric. Therefore, the transmission system 100 can transmit optical signals or electric signals by simply replacing the transmission channel 400.

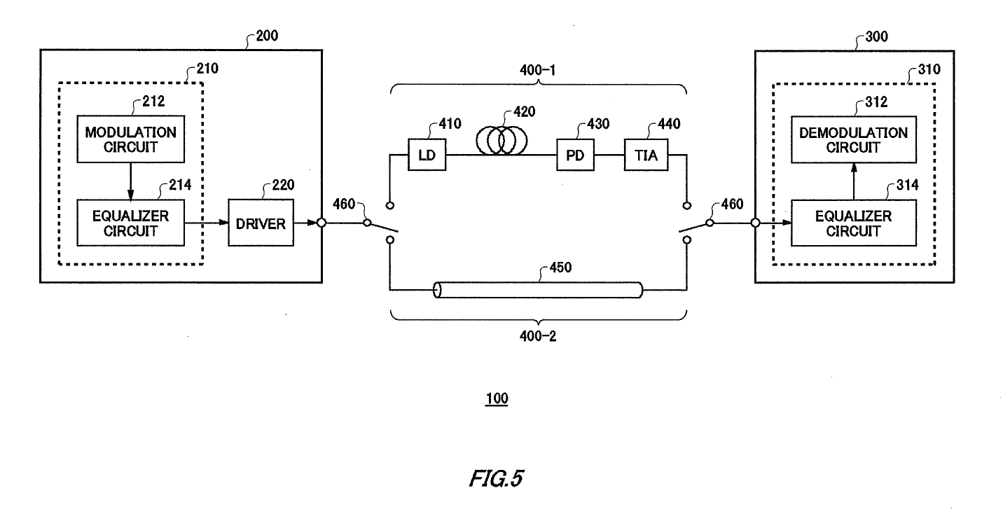

FIG. 5 shows another exemplary configuration of the transmission system 100. The transmission system 100 of the present embodiment is provided with the transmitting device 200, the receiving device 300, the optical transmission channel 400-1, the electric transmission channel 400-2 and a switching section 460. The transmitting device 200 and the receiving device 300 may be the same as the transmitting device 200 and the receiving device 300 described in relation to FIGS. 1 to 4.

The optical transmission channel 400-1 may be the same as the transmission channel 400 described in relation to FIG. 1. The electric transmission channel 400-2 may be the same as the transmission channel 400 described in relation to FIG. 4. The transmission system 100 may further include the characteristic adjusting section 500 described in relation to FIG. 3.

The switching section 460 switches whether the optical transmission channel 400-1 or the electric transmission channel 400-2 is connected between the transmitting device 200 and the receiving device 300. For example, the switching section 460 connects either the optical transmission channel 400-1 or the electric transmission channel 400-2 depending on the transmission distance between the transmitting device 200 and the receiving device 300.

The switching section 460 may measure the attenuation amount when the electric transmission channel 400-2 is connected to transmit data from the transmitting device 200 to the receiving device 300 and, if the attenuation amount is greater than a prescribed threshold value, may switch the transmission channel 400 to be the optical transmission channel 400-1. The characteristic adjusting section 500 may control the equalizing amount in the transmission equalizer circuit 214 and the multilevel value in the modulation circuit 212 based on which transmission channel is selected by the switching section 460. With this configuration, the transmission system 100 can select the appropriate transmission channel to transmit the data.

FIG. 5 shows an example in which one transmitting device 200 and one receiving device 300 are provided, but the transmission system 100 may instead be provided with a plurality of receiving devices 300 corresponding to one transmitting device 200, to perform 1-to-N transmission. The transmission system 100 may be provided with a plurality of receiving devices 300 corresponding to a plurality of transmitting devices 200, to perform N-to-N transmission. In this case, the switching section 460 may select which receiving device 300 each transmitting device 200 is connected to.

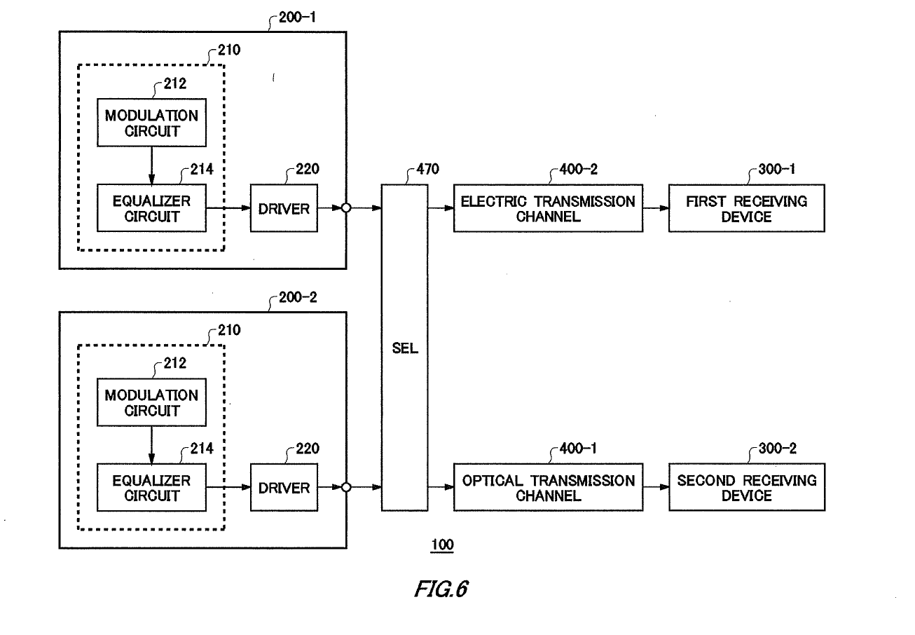

FIG. 6 shows another exemplary configuration of the transmission system 100. The transmission system 100 of the present embodiment is provided with a plurality of transmitting devices 200, a switching section 470, the optical transmission channel 400-1, the electric transmission channel 400-2, and a plurality of receiving devices 300. The transmission system 100 may further be provided with the characteristic adjusting section 500.

Each transmitting device 200 and each receiving device 300 may be the same as the transmitting device 200 and the receiving device 300 described in relation to FIG. 1. The optical transmission channel 400-1 and the electric transmission channel 400-2 may be the same as the optical transmission channel 400-1 and the electric transmission channel 400-2 described in relation to FIG. 5.

Each transmitting device 200 is arranged at substantially the same location. The transmitting devices 200 may be included in a single device. Each receiving device 300 is arranged at a different location. In other words, the receiving devices 300 are arranged such that the transmission distance from the transmitting devices 200 to a first receiving device 300-1 and the transmission distance from the transmitting devices 200 to a second receiving device 300-2 are different.

The electric transmission channel 400-2 is connected to the first receiving device 300-1, which has a transmission distance that is less than a prescribed distance. The optical transmission channel 400-1 is connected to the second receiving device 300-2, which has a transmission distance that is greater than a prescribed distance.

Each transmitting device 200 can be connected to one of the transmission channels 400. In the present embodiment, each transmitting device 200 can be selectively connected to a transmission channel 400 via the switching section 470. As described above, the transmission system 100 can switch between the electric transmission channel 400-2 and the optical transmission channel 400-1. Therefore, each transmitting device 200 can be connected to the plurality of receiving devices 300 at different transmission distances via the transmission channels.

The modulation circuit 212 and the transmission equalizer circuit 214 in each transmitting device 200 may be adjusted based on a characteristic of the transmission channel 400 to which the transmitting device 200 is connected. As described in relation to FIG. 3, the characteristic adjusting section 500 may adjust the cutoff frequency and equalizing amount in each transmission equalizer circuit 214 and the multilevel value in each modulation circuit 212, based on a characteristic of the transmission channel 400 to which the transmitting device 200 is connected.

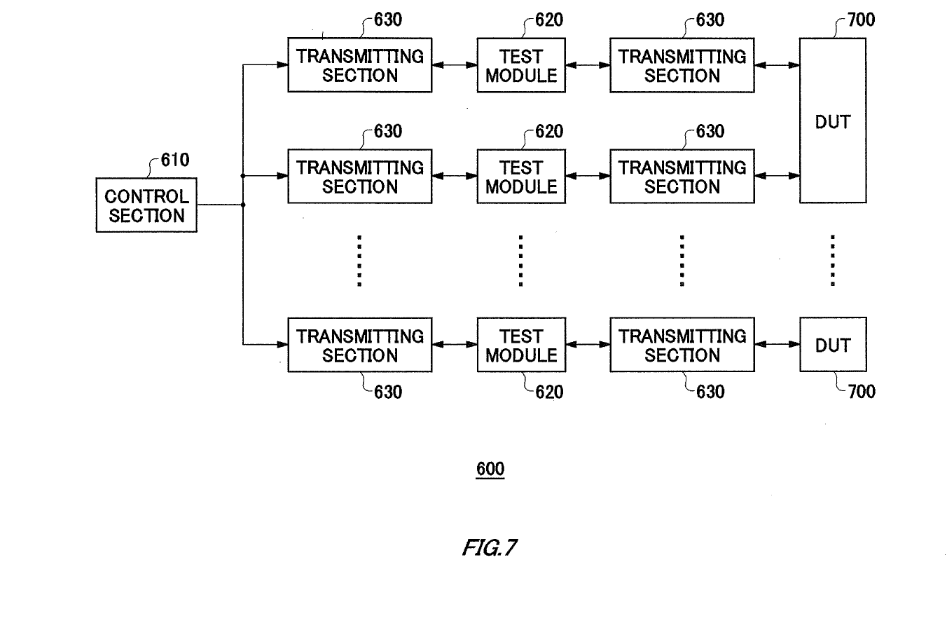

FIG. 7 shows an exemplary configuration of a test device 600 according to another embodiment of the present invention. The test device 600 tests a device under test 700 such as a semiconductor, and is provided with a control section 610, a plurality of transmitting sections 630, and a plurality of test modules 620.

Each test module 620 sends and receives signals to and from a corresponding device under test 700 to test the device under test 700. For example, each test module 620 tests whether the corresponding device under test 700 outputs a prescribed response signal upon receiving a prescribed test signal. Each test module 620 may send and receive signals to and from another test module 620. For example, a certain test module 620 may generate a test signal based on a signal received from another test module 620.

The control section 610 controls each test module 620. For example, the control section 610 may supply each test module 620 with a trigger signal, a clock signal, a pattern signal, and the like for controlling the test module 620.

The transmitting sections 630 transmit signals between the control section 610 and the test modules 620, between the test modules 620 themselves, and between the test modules 620 and the devices under test 700. Each transmitting section 630 may be any one of the transmission systems 100 described in relation to FIGS. 1 to 6. With such a configuration, signals can be transmitted between each circuit using a transmission channel appropriate for the transmission distance between each of the circuits.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

As made clear from the above, the embodiments of the present invention realize a transmission system that that transmits data by using a transmission channel appropriate for the transmission distance between each circuit and performing suitable modulation and equalization according to a characteristic of the transmission channel.

What is claimed is:

1. A transmission system that transmits data, comprising:
a modulating section that modulates amplitude of a predetermined carrier signal according to the data to be transmitted;
an electro-optical converting section that converts a modulated signal output by the modulating section into an optical signal;
an optical fiber that transmits the optical signal;
an optical-electric converting section that converts the optical signal transmitted by the optical fiber into a current signal;
a current-voltage converting section that linearly converts the current signal into a voltage signal; and
a demodulating section that demodulates the voltage signal.

2. The transmission system according to claim 1, which can transmit an electric signal by connecting an electric transmission channel that transmits the electric signal between the modulating section and the demodulating section instead of an optical transmission channel having the electro-optical converting section, the optical fiber, the optical-electric converting section, and the current-voltage converting section.

3. The transmission system according to claim 2, wherein
the modulating section includes a transmission equalizer circuit that adjusts a frequency characteristic of the modulated signal.

4. The transmission system according to claim 3, wherein
the transmission equalizer circuit adjusts the frequency characteristic of the modulated signal based on whether the optical transmission channel or the electric transmission channel is connected between the modulating section and the demodulating section.

5. The transmission system according to claim 3, wherein
the transmission equalizer circuit adjusts the frequency characteristic of the modulated signal based on one of a plurality of cutoff frequencies of elements of a transmission channel connected between the modulating section and the demodulating section.

6. The transmission system according to claim 5, wherein
the transmission equalizer circuit adjusts the frequency characteristic of the modulated signal based on a lowest cutoff frequency from among the cutoff frequencies of the elements of the transmission channel connected between the modulating section and the demodulating section.

7. The transmission system according to claim 5, wherein
the modulating section determines a multilevel value in a direction of amplitude of the modulated signal based on the cutoff frequency of a certain element of the transmission channel and a number of bits to be transmitted per unit time.

8. The transmission system according to claim 7, wherein
the modulating section determines the multilevel value in the direction of the amplitude of the modulated signal based on the lowest cutoff frequency from among the cutoff frequencies of the elements of the transmission channel and the number of bits to be transmitted per unit time.

9. The transmission system according to claim 8, wherein
the modulating section increases the multilevel value in the direction of the amplitude of the modulated signal, when an equalizing amount of the amplitude of the modulated signal in the transmission equalizer circuit exceeds a prescribed threshold value.

10. The transmission system according to claim 2, wherein
the demodulating section includes a reception equalizer circuit that adjusts a frequency characteristic of the voltage signal.

11. The transmission system according to claim 2, further comprising a switching section that switches whether the optical transmission channel or the electric transmission channel is connected between the modulating section and the demodulating section.

12. The transmission system according to claim 11, wherein
the switching section switches whether the optical transmission channel or the electric transmission channel is connected based on a transmission distance between the modulating section and the demodulating section.

13. The transmission system according to claim 12, further comprising a plurality of the demodulating sections arranged at different locations, wherein
the optical transmission channel is connected to demodulating sections having a transmission distance from the modulating section that is greater than or equal to a prescribed distance,
the electric transmission channel is connected to demodulating sections having a transmission distance from the modulating section that is less than the prescribed distance, and
the modulating section is connectable to both the optical transmission channel and the electric transmission channel.

14. A test device that tests a device under test, comprising:
a plurality of test modules that exchange signals with the device under test to test the device under test; and
a transmitting section that transmits a signal at least between the plurality of test modules or between each test module and the device under test, wherein the transmitting section includes:
a modulating section that modulates amplitude of a predetermined carrier signal according to the signal to be transmitted;
an electro-optical converting section that converts a modulated signal output by the modulating section into an optical signal;
an optical fiber that transmits the optical signal;
an optical-electric converting section that converts the optical signal transmitted by the optical fiber into a current signal;
a current-voltage converting section that linearly converts the current signal into a voltage signal; and
a demodulating section that demodulates the voltage signal.
